(19) United States
(12) Patent Application Publication
(10) Pub. No.: US 2009/0093608 A1
(43) Pub. Date: Apr. 9, 2009

(54) POLYIMIDE MATERIAL WITH IMPROVED THERMAL AND MECHANICAL PROPERTIES

(75) Inventors: Ilya L. Rushkin, Acton, MA (US); Gwo S. Swei, Vandalia, OH (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 11/867,529

(22) Filed: Oct. 4, 2007

(51) Int. Cl. C08G 73/10

(52) U.S. Cl. 528/170

(57) ABSTRACT

A method of forming a polymeric material includes forming a solution including at least two solvents and at least two diamines. The at least two diamines include oxydianiline (ODA) in an amount of about 50% to about 90% based on the total moles of the at least two diamines and include m-phenylenediamine (MPD) in an amount of about 10% to about 50% based on the total moles of the at least two diamines. The at least two solvents include a high polarity solvent in an amount of about 40% to about 90% based on the total weight of the at least two solvents and include a low polarity solvent in an amount of about 10% to about 60% based on the total weight of the at least two solvents. The method further includes adding pyromellitic dianhydride (PMDA) to the solution in a ratio of about 0.9 to about 1.05 based on the total moles of the at least two diamines to form a polyamic acid solution. In addition, the method includes imidizing the polyamic acid solution to form a polyimide material.

### FIELD OF THE DISCLOSURE

This disclosure, in general, relates to polyimide materials and in particular, to polyimide materials having improved thermal and mechanical properties and to methods for forming such polyimide materials.

### BACKGROUND

In industries, such as aerospace, automobile manufacturing, and semiconductor manufacturing, intricate components and tools are increasingly being used in high temperature environments. Traditionally, manufacturers have used metal and ceramic materials to form such components and tools based on the tolerance of such materials for high temperatures.

More recently, industry is seeking to use polymeric materials as alternatives to metal and ceramic materials. In general, polymeric materials are less expensive and lighter in weight than both metal and ceramic materials. Typically, polymeric materials are significantly lighter than metal. In addition, polymers often cost less than one-tenth the cost of ceramic materials, can be molded at lower temperatures than ceramic materials, and are easier to machine than ceramic materials. However, unlike metal and ceramic materials, polymeric materials tend to degrade at high temperatures. Typically, at elevated temperatures, polymeric materials lose mechanical strength as well. In addition, when exposed to elevated temperatures in an atmosphere including oxygen, polymeric materials tend to lose mass through oxidation and off gassing. Such a loss of mass often results in changes in the dimensions of an article formed of such polymeric materials. In addition, such a loss in mass typically results in reduced mechanical strength, such as a decrease in tensile strength and elongation properties.

More recently, industry has turned to polymeric materials such as polyimide materials. However, it has proved difficult to provide a polyimide material that has both desirable processing characteristics and desirable thermal stability and mechanical properties. Typically, adjustments to polyimide formulations that result in improved processability tend to negatively impact one or more properties related to thermal stability or mechanical strength. On the other hand, adjustments to polyimide formulations that tend to improve thermal stability or mechanical strength tend to negatively impact processability or other thermal stability or mechanical strength properties. As such, improved polyimide material would be desirable.

### SUMMARY

In a particular embodiment, a polymeric material includes m units of formula I

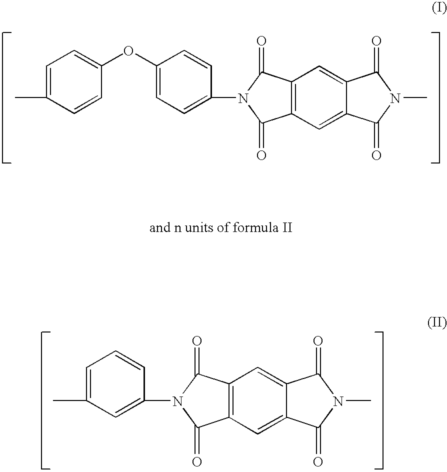

wherein m and n represent mole fractions of the respective units and wherein m is in a range of 0.5 to 0.9 and n is in a range of 0.1 to 0.5. The polymeric material has a Direct Form Tensile Strength of at least about 6.0 ksi and a TGA Weight Loss of not greater than about 13.0%.

In a further embodiment, a molding powder includes a polymeric material that includes m units of formula I

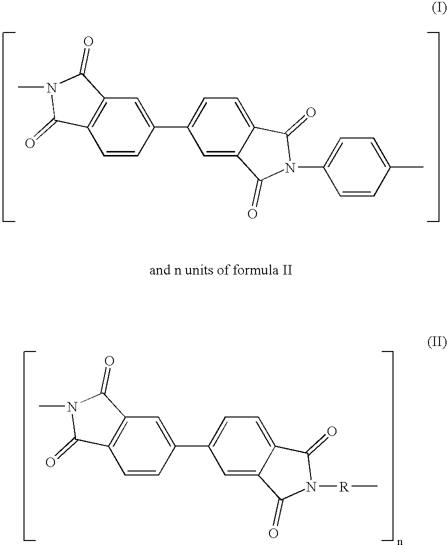

wherein R is 3,4′-oxydianiline or 4,4′-oxydianiline, wherein m and n represent mole fractions of the respective units and wherein m is in a range of 0.5 to 0.95 and n is in a range of 0.05 to 0.5. The molding powder has a Direct Form Tensile Strength of at least about 10.0 ksi and a TGA Weight Loss of not greater than about 3.5%.

In an additional embodiment, a method of forming a polymeric material includes forming a solution including at least two solvents and at least two diamines. The at least two diamines include oxydianiline (ODA) in an amount of about 50% to about 90% based on the total moles of the at least two diamines and include m-phenylenediamine (MPD) in an amount of about 10% to about 50% based on the total moles of the at least two diamines. The at least two solvents include a high polarity solvent in an amount of about 40% to about 90% based on the total weight of the at least two solvents and include a low polarity solvent in an amount of about 10% to about 60% based on the total weight of the at least two solvents. The method further includes adding pyromellitic dianhydride (PMDA) to the solution in a ratio of about 0.9 to about 1.05 based on the total moles of the at least two diamines to form a polyamic acid solution. In addition, the method includes imidizing the polyamic acid solution to form a polyimide material.

In another exemplary embodiment, a method of forming a polymeric material includes forming a solution including at least two solvents and at least two diamines. The at least two diamines include p-phenylenediamine (PPD) in an amount of about 40% to about 60% based on the total moles of the at least two diamines and include m-phenylenediamine (MPD) in an amount of about 40% to about 60% based on the total moles of the at least two diamines. The at least two solvents include a high polarity solvent in an amount of about 40% to about 90% based on the total weight of the at least two solvents and include a low polarity solvent in an amount of about 10% to about 60% based on the total weight of the at least two solvents. Further, the method includes adding diphenyltetracarboxylic acid dianhydride (BPDA) to the solution in a ratio of about 0.9 to about 1.05 based on the total moles of the at least two diamines to form a polyamic acid solution. In addition, the method includes imidizing the polyamic acid solution to form a polyimide material.

In an additional embodiment, a method of forming a polymeric material includes forming a solution including at least two solvents and at least two diamines. The at least two diamines include p-phenylenediamine (PPD) in an amount of about 50% to about 95% based on the total moles of the at least two diamines and include oxydianiline (ODA) in an amount of about 5% to about 50% based on the total moles of the at least two diamines. The at least two solvents include a high polarity solvent in an amount of about 40% to about 90% based on the total weight of the at least two solvents and include a low polarity solvent in an amount of about 10% to about 60% based on the total weight of the at least two solvents. Further, the method includes adding diphenyltetracarboxylic acid dianhydride (BPDA) to the solution in a ratio of about 0.9 to about 1.05 based on the total moles of the at least two diamines to form a polyamic acid solution. In addition, the method includes imidizing the polyamic acid solution to form a polyimide material.

### DESCRIPTION OF THE EMBODIMENTS

In a particular embodiment, a polyimide material has both desirable thermal stability properties and desirable mechanical properties. Furthermore, the polyimide material has desirable processability, including the ability to be direct formed. In particular, the polyimide material is formed from the reaction of a single dianhydride with at least two diamines. The at least two diamines are included in a solvent solution that includes at least one high polarity solvent and at least one low polarity solvent. The dianhydride is added to the solution, forming a polyamic acid solution. The polyamic acid solution is imidized to produce a polyimide material having the desirable processability, thermal stability, and mechanical properties. Alternatively, the polyimide material may be formed through a substitution reaction.

In an exemplary embodiment, formation of the polyimide material using a specific combination of a dianhydride and diamines in conjunction with particular methods of forming the polyimide material result in a polyimide material that is both processable and has desirable thermal stability and mechanical properties.

In particular, one of two methods may be employed. The first method involves reaction of dianhydrides with diamines in the presence of a mixture of solvents to form a high molecular weight polyamic acid, followed by imidization at elevated temperatures. In a second method, polyimide powder is prepared from a concentrated solution of dianhydride diesters with diamine components in a suitable solvent. The concentrated solution is heated to effect polycondensation and imidization reactions.

In a particular embodiment, the first method includes employing a mixed solvent system. For example, the solvent system employed may include at least two solvents: a high polarity solvent and a low polarity solvent. In an example, the high polarity solvent may be a high polarity, high solubility constant solvent in which polyamic acid is soluble. For example, the high polarity solvent may include N-methylpyrrolidone (NMP), N,N′-dimethylformamide (DMF), N,N′-dimethylacetamide (DMAC), or any combination thereof. In a particular example, the high polarity solvent includes N-methylpyrrolidone (NMP).

In a further example, the low polarity solvent may be a low polarity, low solubility constant solvent and may be a poor solvent for polyamic acid. In a particular example, the low polarity solvent may form an azeotrope with water. In an example, the low polarity solvent may include toluene, xylene, ethyl acetate, t-butyl methyl ether or any combination thereof. In a particular example, the low polarity solvent includes xylene.

Based on the total weight of the solvents used in the reaction mixture, the amount of high polarity solvent used in the reaction mixture may be in a range from about 40% to about 90% by weight. For example, the high polarity solvent may be used in an amount of about 40% to about 70%, such as about 50% to about 65% by weight. The amount of low polarity solvent may be about 10% to about 60% based on the total weight of the solvents used in the reaction mixture, such as about 30% to about 60% or even about 30% to about 50% by weight.

In an exemplary embodiment, at least two diamine components are dissolved in the solvents. In an example, the diamine components may be added to the solvents at the same time or separately and dissolved within the solvents. An exemplary diamine includes oxydianiline (ODA), 4,4′-diaminodiphenylpropane, 4,4′-diaminodiphenylmethane, 4,4′-diaminodiphenylamine, benzidine, 4,4′-diaminodiphenyl sulfide, 4,4′-diaminodiphenyl sulfone, 3,3′-diaminodiphenyl sulfone, 4,4′-diaminodiphenyl ether, bis-(4-aminophenyl)diethylsilane, bis-(4-aminophenyl)-phenylphosphine oxide, bis-(4-aminophenyl)-N-methylamine, 1,5-diaminonaphthalene, 3,3′-dimethyl-4,4′-diaminobiphenyl, 3,3′-dimethoxybenzidine, 1,4-bis-(p-aminophenoxy)-benzene, 1,3-bis-(p-aminophenoxy)-benzene, m-phenylenediamine (MPD) or p-phenylenediamine (PPD), or any mixture thereof. The ODA may be 3,4′-oxydianiline or 4,4′-oxydianiline. In particular, the ODA may be 4,4′-oxydianiline. In a particular example, one of the diamines is oxydianiline (ODA). In another example, the diamines include m-phenylenediamine (MPD), p-phenylenediamine (PPD), or a mixture thereof.

The solution including the solvents and the diamines may be heated to an elevated temperature. In particular, the solution may be heated to an elevated temperature at which the low polarity solvent forms an azeotrope with water. For example, the solution may be heated to a temperature of at least about 70° C., such as at least about 100° C., or even at least about 150° C. Once the water is removed, the solution may be cooled.

A dianhydride component may be added to bring about a polycondensation reaction. An exemplary dianhydride includes pyromellitic dianhydride (PMDA), 2,3,6,7-naphthalenetetracarboxylic acid dianhydride, 3,3′,4,4′-diphenyltetracarboxylic acid dianhydride, 1,2,5,6-naphthalenetetracarboxylic acid dianhydride, 2,2′,3,3′-diphenyltetracarboxylic acid dianhydride, 2,2-bis-(3,4-dicarboxyphenyl)-propane dianhydride, bis-(3,4-dicarboxyphenyl)-sulfone dianhydride, bis-(3,4-dicarboxyphenyl)-ether dianhydride, 2,2-bis-(2,3-dicarboxyphenyl)-propane dianhydride, 1,1-bis-(2,3-dicarboxyphenyl)-ethane dianhydride, 1,1-bis-(3,4-dicarboxyphenyl)-ethane dianhydride, bis-(2,3-dicarboxyphenyl)-methane dianhydride, bis-(3,4-dicarboxyphenyl)-methane dianhydride, 3,4,3′,4′-benzophenonetetracarboxylic acid dianhydride, or any mixture thereof. In a particular example, the dianhydride is pyromellitic dianhydride (PMDA). In another example, the dianhydride is benzophenonetetracarboxylic acid dianhydride (BTDA) or diphenyltetracarboxylic acid dianhydride (BPDA). In an example, the ratio of the dianhydride component to the total amount of the diamine components may be between 0.95 and 1.05 based on molar stoichiometry.

The reaction temperature may range from about 20° C. to about 100° C. In particular, the reaction may be allowed to progress to achieve a desired molecular weight of polyamic acid. The molecular weight of the polyamic acid may be inferred from the Inherent Viscosity (IV) of the solution, as described in U.S. Pat. No. 5,886,129. The IV values are typically between 0.2 dl/g and 3.0 dl/g. For example, the IV values may be about 0.6 dl/g to about 2.0 dl/g, such as about 0.7 dl/g to about 1.7 dl/g. As a result, a polyamic acid solution is formed.

In an example, the polyamic acid solution may be heated to facilitate imidization. In an example, the temperature of the polyamic acid is between 120° C. and 190° C. Water formed during the imidization is removed as an azeotrope with the low polarity solvent.

As a result, a polyimide powder is formed. In an example, the polyimide powder may be collected by filtration and optionally washed. For example, the polyimide powder may be washed with a washing solvent. An exemplary washing solvent includes methanol, isopropanol, acetone, or any combination thereof.

A polyimide powder may be further dried. For example, the polyimide powder may be dried under vacuum. In another example, the polyimide powder is dried in a non-reactive atmosphere, such as in the presence of a non-reactive gas. An exemplary non-reactive gas includes nitrogen or a noble gas, such as helium, argon or neon, or any combination thereof, or any combination thereof. In addition, the polyimide powder may be dried at a temperature of about 180° C. to about 350° C.

In a particular example, the polyimide powder produced by the above method has a high surface area of at least 10 m²/g and can be formed into shapes by direct forming techniques. Further, the polyimide powder may be formed into shapes by hot compression molding or isostatic techniques. In particular, select polyimides powders formed through the above method and using particular species of dianhydride and diamines may result in a direct formable polyimide powder with a surface area of at least 10 m²/g and having a desirable thermal stability and mechanical properties.

In a second method, a polyimide powder is prepared from a concentrated solution of dianhydride diester and diamine components in a suitable solvent. For example, a dianhydride diester solution may be formed by reacting a dianhydride with an alcohol. In particular, dianhydride diesters may be derived from the above-identified dianhydrides in the presence of an alcohol, such as methanol, ethanol, propanol, or any combination thereof. To form a concentrated solution, at least two diamine components may be added to the dianhydride diester solution. For example, the diamine components may be selected from the group of diamine components identified above.

The concentrated solution may be heated to a temperature in a range of about 120° C. to about 350° C. In an example, the concentrated solution is heated under vacuum. In another exemplary embodiment, the concentrated solution may be heated in an inert atmosphere, such as a non-reactive gas including a noble gas, nitrogen, or any combination thereof. The polyimide powder may be milled to obtain a desired particle size. In an example, a polyimide powder formed through such a method may be shaped using a method such as hot compressing molding.

The above methods in combination with a specific polyimide formulation provide polyimide materials having the desirable properties, including thermal stability and mechanical strength. In particular, the first method in combination with particular polyimide formulations provides direct formable polyimide materials having strength and thermal stability.

In an exemplary embodiment, the polyimide is formed using one of the above methods. The formulation includes at least one dianhydride, pyromellitic dianhydride (PMDA), and at least two diamines: oxydianiline (ODA) and m-phenylenediamine (MPD). The ODA may be 3,4′-ODA or 4,4′-ODA. The ratio of the dianhydride component to the total of diamine components is in a range of about 0.95 to about 1.05. Accordingly, the resulting polyimide material includes m units of formula I and n units of formula II.

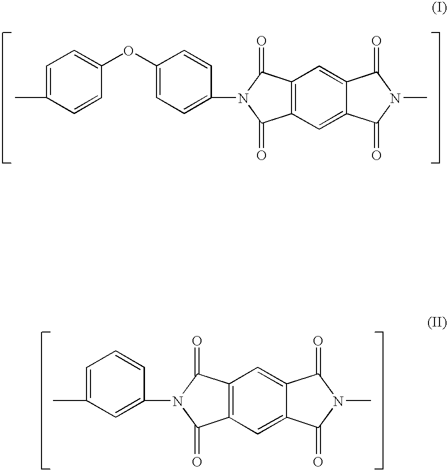

When expressed as a mole fraction, m is in a range of about 0.5 to about 0.9 and n is in a range of about 0.1 to about 0.5. In an example, m may be in a range of about 0.6 to about 0.8, such as about 0.65 to about 0.85. In a further example, n may be in a range of about 0.2 to about 0.4, such as about 0.25 to about 0.35.

For example, ODA and MPD may be reacted with PMDA. The ODA may be included in a reaction solution in an amount of about 50% to about 90% based on the total moles of diamines, such as about 60% to about 80%, or even about 65% to about 85% based on the total moles of diamine. The MPD may be included in a reaction solution in an amount of about 10% to about 50% based on the total moles of diamine, such as about 20% to about 40%, or even about 25% to about 35% based on the total moles of diamine.

In a particular example, the resulting polyimide material is a powder, such as a molding powder. The powder may have a particle size distribution in which 90% of the particles have a particle size not greater than about 650 micrometers, such as not greater than about 500 micrometers, not greater than about 250 micrometers, or even not greater than about 100 micrometers.

Further, the resulting polyimide material may be direct formable, i.e., able to be molded using a direct forming process. Direct forming includes compressing a polymeric powder at a pressure greater than 40,000 psi, such as 55,000 psi, to form a green component and subsequently sintering the green component at a temperature of at least about 350° C. For example, to prepare a tensile bar for testing, a tensile bar is compressed at 55,000 psi and sintered at a temperature of about 413° C. for about 4 hours. The exemplary polyimide material may exhibit a Direct Form Tensile Strength, defined as the tensile strength of the polyimide material when the polyimide material is direct formed as described above, of at least about 6.0 ksi. In an example, the Direct Form Tensile Strength may be at least about 6.5 ksi, such as at least about 7.0 ksi. In addition, the polyimide material may exhibit a Direct Form Elongation-at-break (DFE), defined as the elongation-at-break of the polyimide material when the polyimide material is directed formed as described above, of at least about 1.0%. For example, the DFE may be at least about 1.5%, such as at least about 2.0%.

In addition, the polyimide material may exhibit a desirable thermal stability. In particular, the polyimide material may exhibit a Thermal Gravimetric Analysis (TGA) Weight Loss as defined in accordance with the method described in Example 6 of not greater than about 13.0%. In an example, the TGA Weight Loss may be not greater than about 11.0%, such as not greater than about 10.5%.

In another exemplary embodiment, the polyimide material may be formed in accordance with the above methods using diphenyltetracarboxylic acid dianhydride (BPDA) and at least two diamines: p-phenylenediamine (PPD) and m-phenylenediamine (MPD). The amount of BPDA relative to the total amount of diamine is in a range of about 0.95 to about 1.05. Accordingly, the polyimide material may include m units of formula III and n units of formula IV:

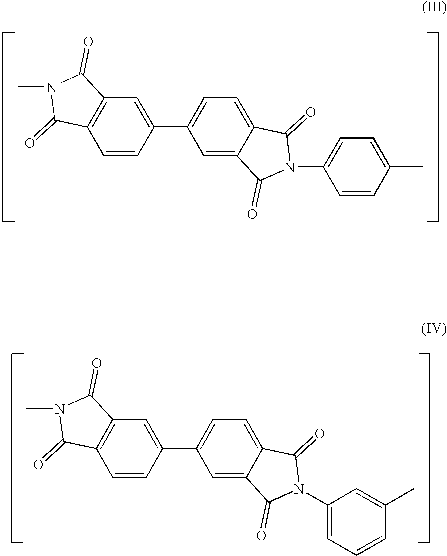

wherein, when expressed as a mole fraction, m is in a range of about 0.4 to about 0.6 and n is in a range of about 0.4 to about 0.6. In an example, m may be in a range of about 0.45 to about 0.55 and n may be in a range of about 0.45 to about 0.55. Alternatively, m may be in a range of about 0.8 to about 0.95 and n may be in a range of about 0.05 to about 0.2.

For example, PPD and MPD may be reacted with BPDA. The PPD may be included in a reaction solution in an amount of about 40% to about 60% based on the total moles of diamines, such as about 45% to about 55% based on the total moles of diamine. Alternatively, PPD may be included in a reaction solution in an amount of about 80% to about 95% based on the total moles of diamine. The MPD may be included in a reaction solution in an amount of about 40% to about 60% based on the total moles of diamine, such as about 45% to about 55%. Alternatively, MPD may be included in an amount of about 5% to about 20% based on the total moles of diamine.

In a particular example, the resulting polyimide material is a powder, such as a molding powder. The powder may have a particle size distribution in which 90% of the particles have a particle size not greater than about 650 micrometers, such as not greater than about 500 micrometers, not greater than about 250 micrometers, or even not greater than about 100 micrometers. Further, the polyimide powder may be compression moldable, such as direct formable. Compression moldable powders are polyimide powders that may be formed into articles through compression and sintering, the sintering being either concurrent with compression or following compression. Direct formable powders are compression moldable powders that may be compressed into a green article and subsequently sintered.

In an exemplary embodiment, the resulting polyimide material is direct formable and may exhibit desirable thermal stability and mechanical properties. In particular, the polyimide material may exhibit a Direct Form Tensile Strength (DFTS) of at least about 6.0 ksi. For example, the DFTS of the polyimide material may be at least about 10.0 ksi, such as at least about 12.0 ksi, at least about 13.0 ksi, at least about 15.0 ksi, or even at least about 16.5 ksi. Further, the polyimide material may exhibit a Direct Form Elongation-at-break (DFE) of at least about 1.0%, such as at least about 2.0%, or even at least about 2.2%.

In addition, the polyimide material may exhibit a desirable TGA Weight Loss. For example, the TGA Weight Loss of the polyimide material may be not greater than about 2.0%, such as not greater than about 1.7%, or even not greater than about 1.6%.

In a further exemplary embodiment, a polyimide material may be formed in accordance with one of the above methods and may include at least one dianhydride, diphenyltetracarboxylic acid dianhydride (BPDA), and at least two diamines: p-phenylenediamine (PPD) and oxydianiline (ODA). The ODA may be 3,4′-ODA or 4,4′-ODA. The formulation may include the dianhydride, BPDA, in a ratio to the total amount of diamine of at least about 0.95 to about 1.05. Accordingly, the polyimide material may include m units of formula V and n units of formula VI:

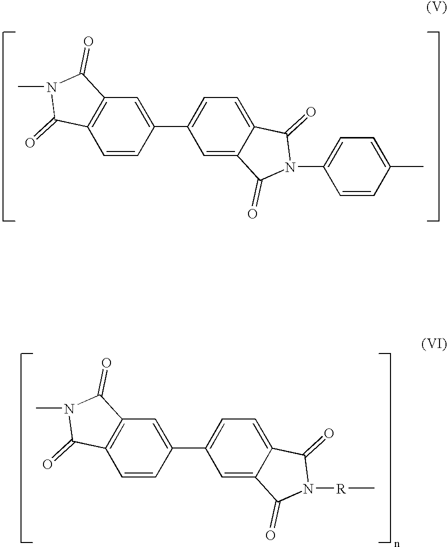

wherein R is 3,4′-ODA or 4,4′-ODA, and wherein, when expressed as mole fractions, m is in a range of about 0.5 to about 0.95 and n is in a range of about 0.05 to about 0.5. For example, m may be in a range of about 0.6 to about 0.9, such as a range of about 0.7 to about 0.9. In a further example, n may be in a range of about 0.1 to about 0.4, such as a range of about 0.1 to about 0.3.

For example, ODA and PPD may be reacted with BPDA. The ODA may be included in a reaction solution in an amount of about 5% to about 50% based on the total moles of diamines, such as about 10% to about 40%, or even about 10% to about 30% based on the total moles of diamine. The PPD may be included in a reaction solution in an amount of about 50% to about 95% based on the total moles of diamine, such as about 60% to about 90%, or even 70% to about 90% based on the total moles of diamine.

In a particular example, the resulting polyimide material is a powder, such as a molding powder. The powder may have a particle size distribution in which 90% of the particles have a particle size not greater than about 650 micrometers, such as not greater than about 500 micrometers, not greater than about 250 micrometers, or even not greater than about 100 micrometers.

When formed in accordance with one of the above methods, the polyimide material may be direct formable and may exhibit desirable thermal stability and mechanical properties. In an example, the direct formable polyimide material exhibits a Direct Form Tensile Strength (DFTS) of at least about 6.0 ksi, such as at least about 10.0 ksi, at least about 12.0 ksi, or even at least about 13.0 ksi. Further, the polyimide material may exhibit a Direct Form Elongation-at-break (DFE) of at least about 1.0%, such as at least about 1.5%, or even at least about 2.0%.

In addition, the polyimide material may exhibit desirable thermal stability properties. For example, the polyimide material may exhibit a TGA Weight Loss of not greater than about 3.5%, such as not greater than about 3.0%, or even not greater than about 2.6%. Further, the polyimide may exhibit a desirable Thermal Oxidative Stability (TOS) Weight Loss, determined in accordance with the method described in Example 6, of not greater than about 4.0%, such as not greater than about 3.0%, or even not greater than about 2.6%.

Particular embodiments of the above formulations formed in accordance with the above described methods result in polyimide materials that advantageously exhibit desirable thermal stability, mechanical properties, and processing characteristics. In particular, when derived in accordance with the first method, the above embodiments of polyimide formulations are direct formable molding powders that provide a unique combination of thermal stability and mechanical strength when direct formed.

### EXAMPLES

BPDA—bis-phenylene dianhydride, supplied by Chriskev Company
PMDA—pyromellitic dianhydride, supplied by Chriskev Company
4,4′ ODA—4,4′oxydianiline, supplied by Jayhawk Co.
3,4′ ODA—3,4′oxydianiline, supplied by Chriskev Company
PPD—para-phenylene diamine, supplied by Aldrich
MPD—meta-phenylene diamine, supplied by Aldrich

### Example 1

### Preparation of BPDA/PPD/4,4′-ODA Polyimide with PPD/ODA Ratio=0.8/02

A solution is prepared by dissolving PPD (20.638 g, 0.191 mol) and 4,4′-ODA (9.552 g, 0.048 mol) in a mixture of 450 g of N-methylpyrrolidone (NMP) and 294 g of xylene in a 2-liter reactor equipped with a mechanical stirrer, a thermocouple, a Dean-Stark adapter, and a reflux condenser. The solution is heated to 150° C., and the residual water is removed as a xylene azeotrope using the Dean-Stark adapter. The mixture is cooled to 50° C., and bis-phenyl dianhydride (BPDA, 70.608 g, 0.24 mol) is added. The BPDA weighing bottle is washed with 97 g of NMP.

After addition, the reaction mixture warms to about 75° C., and the reaction mixture becomes viscous. After the exotherm subsides, the reaction mixture is held at 75° C. for 2 hrs. The Inherent Viscosity (IV) is measured in a 0.5 g/dl solution in NMP according to the published procedure of U.S. Pat. No. 5,886,129. The IV is 1.56 g/dl.

The reaction mixture is slowly heated to 145° C. to effect imidization. The water produced during the imidization reaction is collected as a xylene azeotrope in the Dean-Stark adapter. A fine yellow suspension forms. After 6.9 ml of water is collected, the reaction mixture is cooled to 50° C., and 800 ml of methanol is added.

The reaction mixture is filtered using a Buchner funnel. The filtrate cake is ground through a 16-mesh screen and shaken in a shaker with 1 liter of acetone for 30 min. The suspension is filtered using a Buchner funnel. Twice, the filtrate cake is ground through a 20-mesh screen, is shaken with 1 liter of methanol using a shaker, and is filtered using a Buchner funnel. The filter cake is dried on a filter for about 30 min and is ground through a 16-mesh screen. The light yellow powder is dried in vacuum oven at 210° C. for 16 hrs. The surface area of the product is 63 m²/g and the yield is 81 g or approximately 86%.

### Example 2

### Preparation of BPDA/PPD/4,4′-ODA Polyimide with PPD/4,4′-ODA Ratio=0.66/0.34

A solution is prepared by dissolving PPD (17.285 g, 0.16 mol) and 4,4′-ODA (15.764 g, 0.079 mol) in a mixture of 600.5 g of N-methylpyrrolidone (NMP) and 583 g of xylene in a 2-liter reactor equipped with a mechanical stirrer, a thermocouple, a Dean-Stark adapter, and a reflux condenser. The solution is heated to 160° C., and the residual water is removed as a xylene azeotrope using the Dean-Stark adapter. The mixture is cooled to 50° C., and bis-phenyl dianhydride (BPDA, 70.608 g, 0.24 mol) is added. The BPDA weighing bottle is washed with 111.0 g of NMP.

After addition, the reaction mixture warms to about 75° C., and the reaction mixture becomes viscous. After the exotherm subsides, the reaction mixture is held at 75° C. for 2 hrs. The reaction mixture is slowly heated to 145° C. to effect imidization. The water produced during imidization reaction is collected as a xylene azeotrope in a Dean-Stark adapter. A fine yellow suspension forms.

After 6.6 ml of water is collected, the reaction mixture is cooled to 50° C., and 800 ml of methanol is added. The reaction mixture is filtered using a Buchner funnel. The filtrate cake is ground through a 16-mesh screen and is shaken in a shaker with 1 liter of acetone for 30 min. The suspension is filtered using a Buchner funnel. Twice, the filtrate cake is ground through a 20-mesh screen, is shaken with 1 liter of methanol using a shaker, and is filtered using a Buchner funnel. The filter cake is dried on a filter for about 30 min and is ground through a 16-mesh screen. The light yellow powder is dried in a vacuum oven at 210° C. for 16 hrs. The surface area of the product is 14 m²/g. The yield is 77.5 g or about 82%.

### Example 3

### Preparation of BPDA/PPD/3,4′-ODA Polyimide with PPD/3,4′-ODA Ratio=0.8/02

A solution is prepared by dissolving PPD (20.638 g, 0.191 mol) and 3,4′-ODA (9.552 g, 0.048 mol) in a mixture of 550 g of N-methylpyrrolidone (NMP) and 485 g of xylene in a 2-liter reactor equipped with a mechanical stirrer, a thermocouple, a Dean-Stark adapter, and a reflux condenser. The solution is heated to 145° C., and the residual water is removed as a xylene azeotrope using a Dean-Stark adapter. The mixture is cooled to 50° C., and bis-phenyl dianhydride (BPDA, 70.608 g, 0.24 mol) is added. The BPDA weighing bottle is washed with 116.5 g of NMP.

After addition, the reaction mixture warms to about 75° C., and the reaction mixture becomes viscous. After the exotherm subsides, the reaction mixture is held at 75° C. for 2 hrs. The Inherent Viscosity (IV) is measured in a 0.5 g/dl solution in NMP according to the published procedure of U.S. Pat. No. 5,886,129. The IV is 1.28 g/dl.

The reaction mixture is slowly heated to 145° C. to effect imidization. The water produced during the imidization reaction is collected as a xylene azeotrope in a Dean-Stark adapter. A fine yellow suspension forms.

After 6.2 ml of water is collected, the reaction mixture is cooled to 50° C., and 800 ml of methanol is added. The reaction mixture is filtered using a Buchner funnel. The filtrate cake is ground through a 16-mesh screen and is shaken in a shaker with 1 liter of acetone for 30 min. The suspension is filtered using a Buchner funnel. Twice, the filtrate cake is ground through a 20-mesh screen, is shaken with 1 liter of methanol using a shaker, and is filtered using a Buchner funnel. The filter cake is dried on a filter for about 30 min and is ground through a 16-mesh screen. The light yellow powder is dried in vacuum oven at 210° C. for 16 hrs. The surface area of the product is 36 m²/g. The yield is 77 g or about 82%.

### Example 4

### Preparation of BPDA/PPD/MPD Copolymer with PPD/MPD Ratio=0.5/0.5

A solution is prepared by dissolving PPD (12.9 g, 0.119 mol) and MPD (12.9 g, 0.119 mol) in a mixture of 450 g of N-methylpyrrolidone (NMP) and 303 g of xylene in a 2-liter reactor equipped with a mechanical stirrer, a thermocouple, a Dean-Stark adapter, and a reflux condenser. The solution is heated to 160° C., and the residual water is removed as a xylene azeotrope using a Dean-Stark adapter. The mixture is cooled to 50° C., and bis-phenyl dianhydride (BPDA, 70.608 g, 0.24 mol) is added. The BPDA weighing bottle is washed with 117 g of NMP.

After addition, the reaction mixture warms to about 75° C., and the reaction mixture becomes viscous. After the exotherm subsides, the reaction mixture is held at 75° C. for 2 hrs. The Inherent Viscosity (IV) is measured in a 0.5 g/dl solution in NMP according to the published procedure of U.S. Pat. No. 5,886,129. The IV is 1.21 g/dl.

The reaction mixture is slowly heated to 145° C. to effect imidization. The water produced during the imidization reaction is collected as a xylene azeotrope in a Dean-Stark adapter. A fine yellow suspension forms.

After 6.2 ml of water is collected, the reaction mixture is cooled to 50° C., and 800 ml of methanol is added. The reaction mixture is filtered using a Buchner funnel. The filtrate cake is ground through a 16-mesh screen and is shaken in a shaker with 1 liter of acetone for 30 min. The suspension is filtered using a Buchner funnel. Twice, the filtrate cake is ground through a 20-mesh screen, is shaken with 1 liter of methanol using a shaker, and is filtered using a Buchner funnel. The filter cake is dried on a filter for about 30 min and is ground through a 16-mesh screen. The light yellow powder is dried in vacuum oven at 210° C. for 16 hrs. The surface area of the product is 64 m²/g. The yield is 77 g or about 82%.

### Example 5

### Preparation of PMDA/ODA/MPD Polyimide Powder with ODA/MPD Ratio=0.7/0.3

A solution is prepared by dissolving oxydianiline (ODA, 50.06 g, 0.25 mol) and MPD (11.59 g, 0.107 mol) in a mixture of 340 g of N-methylpyrrolidone (NMP) and 421 g of xylene in a 2-liter reactor equipped with a mechanical stirrer, a thermocouple, a Dean-Stark adapter, and a reflux condenser. The solution is heated to 155° C., and the residual water is removed as a xylene azeotrope by means of the Dean-Stark adapter.

The mixture is cooled to 60° C., and pyromellitic dianhydride (PMDA, 78.52 g, 0.360 mol) is added using a powder funnel. The PMDA weighing bottle and the powder funnel are washed with 100 g of NMP. After addition, the reaction mixture warms to about 81° C., and the reaction mixture becomes viscous. After the exotherm subsides, the reaction mixture is held at 75° C. for 2 hrs.

The reaction mixture is slowly heated to 155° C. to effect imidization. The water produced during the imidization reaction is collected as a xylene azeotrope in a Dean-Stark adapter. A fine yellow suspension forms. After 10.6 ml of water is collected, the reaction mixture is cooled to 50° C., and 1 liter of methanol is added. The reaction mixture is filtered using a Buchner funnel.

The filtrate wet cake is shaken in a shaker with 2 liters of methanol. The suspension is passed through a 16-mesh screen and is filtered using a Buchner funnel. The filtrate wet cake is shaken in a shaker with 2 liters of methanol, is passed through a 16-mesh screen, and is filtered using a Buchner funnel. The filtrate wet cake is shaken in a shaker with 2 liters of methanol, is passed through a 35-mesh screen, and is filtered using a Buchner funnel. The filter cake is dried on a filter for about 30 min and is ground through a 16-mesh screen. The light yellow powder is dried in vacuum oven at 210° C. for 16 hrs. The surface area of the product is approximate 95 m²/g. The yield is approximately 119.6 g or 94%.

### Comparative Example 1

### Preparation of PMDA/ODA Polyimide Powder

A polyimide sample was prepared from PMDA/ODA in accordance with the published procedure of Example 1 of US Patent Publication No. 2007/0154717 (incorporated herein by reference in its entirety), absent metal oxide additive.

### Comparative Example 2

### Preparation of BPDA/PPD Polyimide Powder

A solution is prepared by dissolving PPD (34.4 g, 0.318 mol) in a mixture of 700 g of N-methylpyrrolidone (NMP) and 137.72 g of xylene in a 2-liter reactor equipped with a mechanical stirrer, a thermocouple, a Dean-Stark adapter, and a reflux condenser. The solution is heated to 155° C., and the residual water is removed as a xylene azeotrope using a Dean-Stark adapter. The mixture is cooled to 50° C., and bis-phenyl dianhydride (BPDA, 94.14 g, 0.32 mol) is added using a powder funnel. The BPDA weighing bottle and the powder funnel are washed with 180.43 g of NMP. After the initial exotherm subsides, the reaction mixture is kept at 60° C. for 16 hrs. The Inherent Viscosity (IV) is measured in a 0.5 g/dl solution in NMP and is approximately 1.71 dl/g.

Xylene (303.8 g) is added to the reaction mixture and the reaction mixture is slowly heated to 145° C. to effect imidization. The water produced during imidization reaction is collected as a xylene azeotrope in a Dean-Stark adapter. A fine yellow suspension forms. After 8.0 ml of water is collected, the reaction mixture is cooled to 50° C., and 800 ml of methanol is added.

The reaction mixture is filtered using a Buchner funnel. The filtrate wet cake is shaken in a shaker with 2 liters of methanol. The suspension is passed through a 20-mesh screen and is filtered using a Buchner funnel. The filtrate wet cake is stirred with 2 liters of methanol using a mechanical stirrer and is filtered using a Buchner funnel. The filtrate wet cake is stirred with 2 liters of methanol using a mechanical stirrer, is passed through a 35-mesh screen, and is filtered using a Buchner funnel. The filter cake is dried on a filter for about 30 min and is ground through a 16-mesh screen. The light yellow powder is dried in a vacuum oven at 210° C. for 16 hrs. The surface area of the product is approximately 29 m²/g.

### Comparative Example 3

### Preparation of BPDA/4,4′-ODA Polymer

A solution is prepared by dissolving ODA (49.65 g, 0.248 mol) in a mixture of 310.0 g of N-methylpyrrolidone (NMP) and 348 g of xylene in 2-liter reactor equipped with a mechanical stirrer, a thermocouple, a Dean-Stark adapter, and a reflux condenser. The solution is heated to 145° C., and the residual water is removed as a xylene azeotrope using a Dean-Stark adapter. The mixture is cooled to 50° C., and bis-phenyl dianhydride (BPDA, 73.55 g, 0.25 mol) is added. The BPDA weighing bottle is washed with 160.0 g of NMP.

After addition, the reaction mixture warms to about 75° C., and the reaction mixture becomes viscous. After the exotherm subsides, the reaction mixture is held at 60° C. for 2 hrs. The Inherent Viscosity (IV) is measured in 0.5 g/dl solution in NMP according to the published procedure of U.S. Pat. No. 5,886,129. The IV is 1.57 g/dl.

The reaction mixture is slowly heated to 145° C. to effect imidization. The water produced during the imidization reaction is collected as a xylene azeotrope in a Dean-Stark adapter. A fine yellow suspension forms.

After 7.2 ml of water is collected, the reaction mixture is cooled to 50° C., and 800 ml of methanol is added. The reaction mixture is filtered using a Buchner funnel. The filtrate cake is ground through a 16-mesh screen and is shaken in a shaker with 1 liter of acetone for 30 min. The suspension is filtered using a Buchner funnel. Twice, the filtrate cake is ground through a 20-mesh screen, is shaken with 1 liter of methanol using a shaker, and is filtered using a Buchner funnel. The filter cake is dried on a filter for about 30 min and is ground through a 16-mesh screen. The light yellow powder is dried in a vacuum oven at 210° C. for 16 hrs. The yield is 92.0 g or about 81%.

### Example 6

### Evaluation of Thermal and Mechanical Properties of Polyimide Powders Prepared in Examples 1-5 and in Comparative Examples 1-3

A sample of about 10 mg of polyimide powder is placed into a sample pan of a thermal gravimetric analyzer and the sample is subjected to heating in air according to the following program:

### 1. Heat to 300° C. at 10° C./min

### 2. Hold at 300° C. for 30 min

### 3. Heat to 450° C. at 10° C./min

### 4. Hold at 450° C. for 5 hrs

The relative weight loss, herein referred to as the Thermal Gravimetric Analysis (TGA) Weight Loss, during the 450° C. hold is measured and reported. See Table 1.

TABLE 1

| | | | | | | Comp. |
|---|---|---|---|---|---|---|
| Material | Ex. 1 | Ex. 2 | Ex. 5 | Comp. Ex. 1 | Comp. Ex. 2 | Ex. 3 |
| TGA Weight | 2.5 | 1.5 | 10 | 14 | 1.3 | 14.4 |
| Loss (%) | | | | | | |

Table 1 shows that the polymer of Comparative Example 1 and 3 have inferior thermal stability compared to materials of Examples 1, 2, and 5 and in Comparative Example 2. In particular, Example 5 has improved TGA Weight Loss relative to Comparative Example 1.

Resins of Examples 1-5, as well as, Comparative Examples 2 and 3 are tested according to ASTM procedure D-638. Tensile bars are direct formed at 55,000 psi and are sintered for 4 hrs at 413° C. The test provides a Direct Form Tensile Strength (DFTS) and a Direct Form Elongation-at-break (DFE). See Table 2.

TABLE 2

| Material | DFTS (psi) | DFE (%) |
|---|---|---|
| Example 1 | 16 | 5 |
| Example 2 | 16 | 6 |
| Example 3 | 11 | |
| Example 4 | 18 | 3 |
| Example 5 | 7.2 | 2.4 |
| Comparative Example 2 | 5.1 | 0.5 |
| Comparative Example 3 | 6 | 2.5 |

Table 2 shows that materials of Examples 1, 2, 3, 4, and 5 exhibit better mechanical properties than the material of Comparative Examples 2 and 3.

Tensile bars prepared in Examples 1-4 and in Comparative Examples 1 and 2 are subjected to thermal oxidative stability test (TOS). The TOS test is performed by weighing the tensile bars at room temperature, exposing the tensile bars or part of tensile bar to a temperature of 371° C. at 60 psi of air pressure for 100 hrs. The tensile bars or parts of tensile bars are weighed again and the relative weight loss is determined. TOS Weight Loss is the relative weight loss determined by the method above. See Table 3.

TABLE 3

| Material | TOS (%) |
|---|---|
| Example 1 | 1.7 |
| Example 2 | 2.6 |
| Example 3 | 1.9 |
| Example 4 | 2.2 |
| Comparative Example 1 | 7 |
| Comparative Example 2 | 1.5 |

As can be seen from Tables 1, 2, and 3, the materials of Examples 1, 2, 3, 4, and 5 have better thermal stability measured by TOS than materials of Comparative Example 1. The material of Comparative Example 2 exhibits desirable thermal stability, but has inferior mechanical properties.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A polymeric material comprising m units of formula I 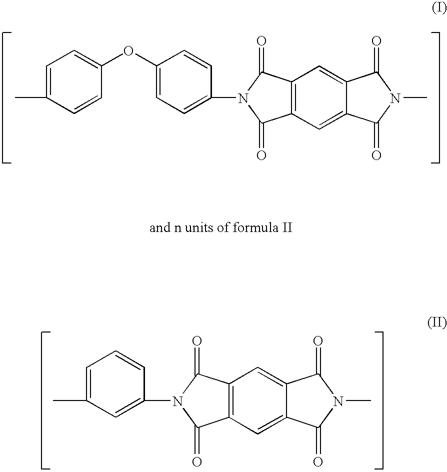
wherein m and n represent mole fractions of the respective units and wherein m is in a range of about 0.5 to about 0.9 and n is in a range of about 0.1 to about 0.5, and wherein the polymeric material has a Direct Form Tensile Strength of at least about 6.0 ksi and a TGA Weight Loss of not greater than about 13.0%.

2. The polymeric material of claim 1, wherein the Direct Form Tensile Strength is at least about 6.5 ksi.

3. The polymeric material of claim 2, wherein the Direct Form Tensile Strength is at least about 7.0 ksi.

4. The polymeric material of claim 1, wherein the polymeric material exhibits a Direct Form Elongation-at-break of at least about 1.0%.

5. The polymeric material of claim 4, wherein the Direct Form Elongation-at-break is at least about 1.5%.

6. (canceled)

7. The polymeric material of claim 1, wherein the TGA Weight Loss is not greater than about 11.0%.

8. (canceled)

9. The polymeric material of claim 1, wherein the polymeric material is a molding powder.

10. The polymeric material of claim 9, wherein the molding powder has a particle distribution in which 90% of the particles have a particle size not greater than 500 micrometers.

11. The polymeric material of claim 1, wherein the polymeric material is direct formable.

12. The polymeric material of claim 1, wherein the polymeric material has surface area of at least 10 m²/g.

13-26. (canceled)

27. A method of forming a polymeric material, the method comprising:
forming a solution including at least two solvents and at least two diamines, wherein the at least two diamines include oxydianiline (ODA) in an amount of about 50% to about 90% based on the total moles of the at least two diamines and include m-phenylenediamine (MPD) in an amount of about 10% to about 50% based on the total moles of the at least two diamines, wherein the at least two solvents include a high polarity solvent in an amount of about 40% to about 90% based on the total weight of the at least two solvents and include a low polarity solvent in an amount of about 10% to about 60% based on the total weight of the at least two solvents;
adding pyromellitic dianhydride (PMDA) to the solution in a ratio between about 0.9 and about 1.05 based on the total moles of the at least two diamines to form a polyamic acid solution; and
imidizing the polyamic acid solution to form a polyimide material.

28. The method of claim 27, wherein the low polarity solvent is included in an amount of about 30% to about 50% based on the total weigh of the at least two solvents.

29. The method of claim 27, further comprising heating the solution to at least about 100° C. prior to adding the PMDA.

30. (canceled)

31. The method of claim 27, wherein imidizing includes heating the polyamic acid solution to at least about 100° C.

32-37. (canceled)

38. The method of claim 27, wherein the high polarity solvent is selected from the group consisting of N-methylpyrrolidone (NMP), N,N′-dimethylformamide (DMF), and N,N′-dimethylacetamide (DMAC).

39. (canceled)

40. The method of claim 27, wherein the low polarity solvent is selected from the group consisting of toluene, xylene, ethyl acetate, and t-butyl methyl ether.

41. (canceled)

42. The method of claim 27, wherein the polyimide material has a surface area of at least 10 m²/g.

43. A method of forming a polymeric material, the method comprising:
forming a solution including at least two solvents and at least two diamines, wherein the at least two diamines include p-phenylenediamine (PPD) in an amount of about 40% to about 60% based on the total moles of the at least two diamines and include m-phenylenediamine (MPD) in an amount of about 40% to about 60% based on the total moles of the at least two diamines, wherein the at least two solvents include a high polarity solvent in an amount of about 40% to about 90% based on the total weight of the at least two solvents and include a low polarity solvent in an amount of about 10% to about 60% based on the total weight of the at least two solvents;
adding diphenyltetracarboxylic acid dianhydride (BPDA) to the solution in a ratio between about 0.9 and about 1.05 based on the total moles of the at least two diamines to form a polyamic acid solution; and
imidizing the polyamic acid solution to form a polyimide material.

44. The method of claim 43, wherein the low polarity solvent is included in an amount of about 30% to about 50% based on the total weigh of the at least two solvents.

45. The method of claim 43, further comprising heating the solution to at least about 100° C. prior to adding the BPDA.

46. The method of claim 45, further comprising cooling the solution to a temperature of in a range of about 20° C. to about 100° C. prior to adding the BPDA and after heating the solution to at least about 100° C.

47. The method of claim 43, wherein imidizing includes heating the polyamic acid solution to at least about 100° C.

48-53. (canceled)

54. The method of claim 43, wherein the high polarity solvent is selected from the group consisting of N-methylpyrrolidone (NMP), N,N′-dimethylformamide (DMF), and N,N′-dimethylacetamide (DMAC).

55. (canceled)

56. The method of claim 43, wherein the low polarity solvent is selected from the group consisting of toluene, xylene, ethyl acetate, and t-butyl methyl ether.

57. (canceled)

58. The method of claim 43, wherein the polyimide powder is a direct formable powder having a Direct Form Tensile Strength of at least about 6.0 ksi.

59-60. (canceled)

61. The method of claim 43, wherein the polyimide material has a surface area of at least 10 m²/g.

62-77. (canceled)
